(19) United States
(12) Patent Application Publication
(10) Pub. No.: US 2020/0097967 A1
(43) Pub. Date: Mar. 26, 2020

(54) METHOD AND SYSTEM FOR REFUND PROCESSING VIA BLOCKCHAIN

(71) Applicant: MASTERCARD INTERNATIONAL INCORPORATED, Purchase, NY (US)

(72) Inventors: Rakesh Patel, Gurgaon (IN); Ankur Arora, New Delhi (IN); Aditya Koduri, Gurgaon (IN)

(73) Assignee: MASTERCARD INTERNATIONAL INCORPORATED, Purchase, NY (US)

(21) Appl. No.: 16/142,140

(22) Filed: Sep. 26, 2018

(51) Int. Cl. G06Q 20/40; G06Q 20/06; G06Q 20/38

(52) U.S. Cl. CPC G06Q 20/407; G06Q 20/06; G06Q 2220/00; G06Q 20/3829; G06Q 20/3825

(57) ABSTRACT

A method for processing merchant-bypassing refunds includes: storing blockchain data including blockchain values, each including a transaction identifier, recipient address, sender address, and transaction amount; receiving a refund request including a specific identifier; identifying a specific blockchain value that includes the specific identifier; receiving a transaction request including a buyer digital signature, merchant address, and spending amount, where the spending amount is greater than the transaction amount in the specific blockchain value; generating a new transaction value that includes the buyer digital signature, a first transaction pair comprising a refund address and the transaction amount in the specific blockchain value, and a second transaction pair comprising the merchant address and a remainder amount based on a difference between the spending amount and the transaction amount in the specific blockchain value; and transmitting the generated new blockchain value to a node in a blockchain network.

### FIELD

The present disclosure relates to the processing of refunds for blockchain and fiat payment transactions, specifically the use of a subsequent merchant transaction to bypass merchant involvement in a refund issued for a past merchant transaction.

### BACKGROUND

On any given day, billions of payment transactions take place throughout the world. As with any exchange between two parties, one of the parties may decide after a time that they would like to reverse the transaction, which results in a refund taking place. Traditionally, refunds operate by a consumer approaching a merchant and asking them to reverse a past transaction. Often times, the consumer will be requested to provide a reason (e.g., defective product, product is the wrong size, etc.), but some merchants offer refunds on purchases using a no questions asked policy.

However, as beneficial as refunds may be for a consumer, the processing time for a refund can take hours, days, or even weeks. Even in cases where the merchant initiates the refund using their point of sale system quickly, the processing time for payment of the refunded amount from the merchant to the consumer may be significant. In some instances, merchants will even make such slow processing times intentionally, in an attempt to dissuade consumers from seeking a refund or to entice the consumer into a different refund option (e.g., a gift card for the merchant instead of returned cash). For consumers that have a low credit limit or utilize a debit card, slow processing times for a refund can be extremely prohibitive.

Thus, there is a need for an improved refunding experience for any type of payment transaction where a refund payment can be processed extremely quickly, while also preventing a merchant from unduly delaying the process.

### SUMMARY

The present disclosure provides a description of systems and methods for the processing of merchant-bypassing refunds. When a transaction has occurred that the consumer involved in the transactions wants a refund for, a processing server reroutes payment on the next transaction for where payment is intended for the target of the refund (e.g., a merchant) such that the refund amount is paid directly to the consumer receiving the refund, with any excess still going to the intended party. The result is that the consumer can get their money immediately, regardless of any attempted delay by the merchant, while also enabling the merchant to provide refunds without having to initiate any payments directly to consumers. As a result, the refund system is improved significantly, and can be easily adapted to any type of currency involved.

A method for processing merchant-bypassing refunds includes: storing, in a memory of a processing server, blockchain data associated with a blockchain, wherein the blockchain data includes at least a plurality of blockchain data values, each blockchain data value including at least a transaction identifier, a recipient address, a sender address, and a transaction amount; receiving, by a receiver of the processing server, a refund request, wherein the refund request includes at least a specific identifier; identifying, by a processing device of the processing server, a specific blockchain data value of the plurality of blockchain data values where the included transaction identifier corresponds to the specific identifier; receiving, by the receiver of the processing server, a transaction request, wherein the transaction request includes at least a buyer digital signature, a merchant address, and a spending amount, where the spending amount is greater than the transaction amount included in the specific blockchain data value; generating, by the processing device of the processing server, a new blockchain transaction value, wherein the new blockchain transaction value includes at least the buyer digital signature, a first transaction pair comprising a refund address and the transaction amount included in the specific blockchain data value, and a second transaction pair comprising the merchant address and a remainder amount based on a difference between the spending amount and the transaction amount included in the specific blockchain data value; and transmitting, by a transmitter of the processing server, the generated new blockchain transaction value to a node in a blockchain network associated with the blockchain.

Another method for processing merchant-bypassing refunds includes: storing, in a memory of a processing server, a plurality of transaction records, wherein each transaction record corresponds to a processing payment transaction and includes at least a transaction identifier, receiving account number, sending account number, and a transaction amount; receiving, by a receiver of the processing server, a refund request, wherein the refund request includes at least a specific identifier; identifying, by a processing device of the processing server, a specific transaction record of the plurality of transaction records where the included transaction identifier corresponds to the specific identifier; receiving, by the receiver of the processing server, a first authorization request, wherein the first authorization request is formatted according to one or more standards and includes a plurality of data elements configured to store at least a buying account number, a merchant account number, and a spending amount, where the spending amount is greater than the transaction amount included in the specific transaction record; generating, by the processing device of the processing server, a second authorization request, wherein the second authorization request is formatted according to the one or more standards and includes a plurality of data elements configured to store at least the sender account number included in the specific transaction record, the buying account number, and the transaction amount included in the specific transaction record; generating, by the processing device of the processing server, a third authorization request, wherein the third authorization request is formatted according to the one or more standards and includes a plurality of data elements configured to store at least the buying account number, the merchant account number, and a remainder amount based on a difference between the spending amount and the transaction amount included in the specific transaction record; and transmitting, by a transmitter of the processing server, the second authorization request and the third authorization request for processing.

A system for processing merchant-bypassing refunds includes: a memory of a processing server configured to store blockchain data associated with a blockchain, wherein the blockchain data includes at least a plurality of blockchain data values, each blockchain data value including at least a transaction identifier, a recipient address, a sender address, and a transaction amount; a receiver of the processing server configured to receive a refund request, wherein the refund request includes at least a specific identifier; a processing device of the processing server configured to identify a specific blockchain data value of the plurality of blockchain data values where the included transaction identifier corresponds to the specific identifier; and a transmitter of the processing server, wherein the receiver of the processing server is further configured to receive a transaction request, wherein the transaction request includes at least a buyer digital signature, a merchant address, and a spending amount, where the spending amount is greater than the transaction amount included in the specific blockchain data value, the processing device of the processing server is further configured to generate a new blockchain transaction value, wherein the new blockchain transaction value includes at least the buyer digital signature, a first transaction pair comprising a refund address and the transaction amount included in the specific blockchain data value, and a second transaction pair comprising the merchant address and a remainder amount based on a difference between the spending amount and the transaction amount included in the specific blockchain data value, and the transmitter of the processing server is configured to transmit the generated new blockchain transaction value to a node in a blockchain network associated with the blockchain.

Another system for processing merchant-bypassing refunds includes: a memory of a processing server configured to store a plurality of transaction records, wherein each transaction record corresponds to a processing payment transaction and includes at least a transaction identifier, receiving account number, sending account number, and a transaction amount; a receiver of the processing server configured to receive a refund request, wherein the refund request includes at least a specific identifier; a processing device of the processing server configured to identify a specific transaction record of the plurality of transaction records where the included transaction identifier corresponds to the specific identifier; and a transmitter of the processing server, wherein the receiver of the processing server is further configured to receive a first authorization request, wherein the first authorization request is formatted according to one or more standards and includes a plurality of data elements configured to store at least a buying account number, a merchant account number, and a spending amount, where the spending amount is greater than the transaction amount included in the specific transaction record, the processing device of the processing server is further configured to generate a second authorization request, wherein the second authorization request is formatted according to the one or more standards and includes a plurality of data elements configured to store at least the sender account number included in the specific transaction record, the buying account number, and the transaction amount included in the specific transaction record, and generate a third authorization request, wherein the third authorization request is formatted according to the one or more standards and includes a plurality of data elements configured to store at least the buying account number, the merchant account number, and a remainder amount based on a difference between the spending amount and the transaction amount included in the specific transaction record, and the transmitter of the processing server is configured to transmit the second authorization request and the third authorization request for processing.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for processing merchant-bypassing refunds in accordance with exemplary embodiments.

FIG. 2 is a block diagram illustrating the processing server of the system of FIG. 1 for processing refunds that bypass merchants in accordance with exemplary embodiments.

FIG. 3 is a flow diagram illustrating a process for the processing of a merchant-bypassing refund in the system of FIG. 1 in accordance with exemplary embodiments.

FIGS. 4 and 5 are flow charts illustrating exemplary methods for processing merchant-bypassing refunds in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by Mastercard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

System for Merchant-Bypassing Refunds

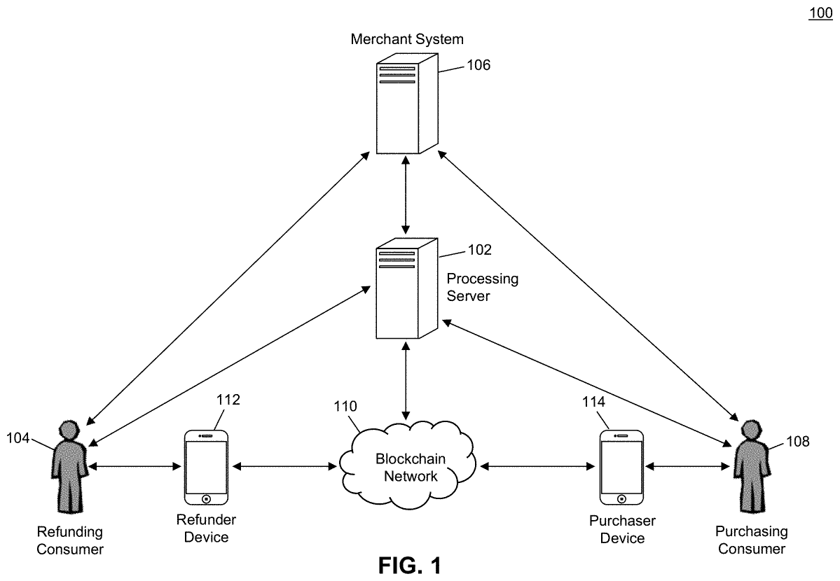

FIG. 1 illustrates a system 100 for the processing of refunds to a consumer for traditional or blockchain transactions involving a merchant that are provided directly from a subsequent transaction with the merchant, thereby bypassing the merchant.

The system 100 may include a processing server 102. The processing server 102, discussed in more detail below, may be configured to process refunds for a refunding consumer 104 that bypass a merchant system 106. In the system 100, a refunding consumer 104 may conduct a payment transaction with a merchant system 106. The payment transaction may be a traditional payment transaction that is conducted using a fiat currency, or a blockchain transaction that is conducted using a blockchain currency, as discussed in more detail below. The payment transaction between the refunding consumer 104 and the merchant system 106, referred to herein as the “initial payment transaction,” may be processed and completed such that payment has been made from the refunding consumer 104 to the merchant system 106.

The refunding consumer 104 may have a desire to receive a refund for the initial payment transaction. In a traditional system, the refunding consumer 104 would contact the merchant system 106 and request the refund, which may be processed based on the merchant's policies, and may take days or even weeks for the refunding consumer 104 to receive payment back from the merchant system 106 for the initial payment transaction. In the system 100, the refunding consumer 104 may request a refund for the initial payment transaction from the processing server 102. The processing server 102 may provide an interface to the refunding consumer 104 through which the refunding consumer 104 may request a refund. Such an interface may be a web interface, accessed via a web site navigated to by the refunding consumer 104, an application program executed by a computing device used by the refunding consumer 104 (e.g., the refunder device 112, discussed in more detail below), etc. In some cases, the interface may be provided through the merchant system 106. For instance, the merchant system 106 may enable the refunding consumer 104 to request a refund through their system, which may be processed by the processing server 102 (e.g., by forwarding the request from the refunding consumer 104 thereto).

In the request for refund, the refunding consumer 104 may identify the transaction for which a refund is requested. For a traditional payment transaction, each payment transaction may have a transaction identifier or other unique value associated therewith, which may be provided to the processing server 102 by the refunding consumer 104. In some instances, the refunding consumer 104 may provide information associated with the merchant system 106, their own transaction account used to fund the initial payment transaction, and the initial transaction itself for identification of the initial transaction by the processing server 102. For example, the refunding consumer 104 may provide all or a portion of their primary account number, the name of the merchant, and the date and/or amount of the initial payment transaction, which may be used by the processing server 102 to identify the initial payment transaction. In cases where the refunding consumer 104 may want the refund payment provided to a different transaction account than the transaction account used to fund the initial payment transaction, the request for a refund may also include a primary account number or other account details for the different transaction account.

In embodiments where the initial payment transaction may be a blockchain transaction, the refunding consumer 104 may provide information associated with their blockchain wallet. The blockchain wallet may be associated with a blockchain network 110 that is used to transmit and receive blockchain currency in electronic payment transactions conducted via the blockchain network 110. A blockchain wallet may be an application program that is executed by a computing device possessed by the refunding consumer 104, referred to herein as the refunder device 112. The refunder device 112 may be any type of computing device suitable for possessing and utilizing a blockchain wallet, such as a desktop computer, laptop computer, tablet computer, notebook computer, cellular phone, smart phone, smart watch, smart television, wearable computing device, implantable computing device, etc. A blockchain wallet may include a private key of a cryptographic key pair that is used to generate digital signatures that serve as authorization by the refunding consumer 104 for a blockchain transaction, where the digital signature can be verified by the blockchain network 110 using the public key of the cryptographic key pair. In some cases, the term “blockchain wallet” may refer specifically to the private key.

The blockchain network 110 may be comprised of a plurality of nodes. Each node may be a computing system that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. The blockchain may be a distributed ledger that is comprised of at least a plurality of blocks. Each block may include at least a block header and one or more data values. Each block header may include at least a timestamp, a block reference value, and a data reference value. The timestamp may be a time at which the block header was generated, and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single node in the blockchain network 110 prior to the generation and addition of a new block to the blockchain in order for the change to be made permanent. Computational and communication limitations may make such a modification exceedingly difficult, if not impossible, thus rendering the blockchain immutable.

Each blockchain data value may correspond to a blockchain transaction. A blockchain transaction may consist of at least: a digital signature of the sender of currency (e.g., the refunding consumer 104) that is generated using the sender's private key, a blockchain address of the recipient of currency (e.g., the merchant system 106) generated using the recipient's public key, and a blockchain currency amount that is transferred. In some blockchain transactions, the transaction may also include one or more blockchain addresses of the sender where blockchain currency is currently stored (e.g., where the digital signature proves their access to such currency), as well as an address generated using the sender's public key for any change that is to be retained by the sender. In some cases, a blockchain transaction may also include the sender's public key, for use by any entity in validating the transaction. For the processing of a blockchain transaction, such data may be provided to a node in the blockchain network 110, either by the sender (e.g., via the refunder device 112) or the recipient (e.g., by the merchant system 106). The node may verify the digital signature and the sender's access to the funds, and then include the blockchain transaction in a new block. The new block may be validated by other nodes in the blockchain network 110 before being added to the blockchain and distributed to all of the nodes in the blockchain network 110.

In a standard blockchain transaction, the refunding consumer 104 may thus generate a digital signature using the refunder device 112 using the private key thereof. The merchant system 106 may generate a blockchain address using its public key, which may be provided to the refunder device 112. In some cases, the merchant system 106 may provide the refunder device 112 with its public key, where the refunder device 112 may generate the blockchain address. The refunder device 112 may then submit the required information to a node in the blockchain network 110 for processing. In some instances, the node may return a blockchain transaction identifier to the refunder device 112, which may be a value that is unique to that blockchain transaction for identification thereof. In such traditional transactions, the merchant system 106 is required to generate blockchain address or distribute its public key, and, in some cases, may be required to submit the transaction data directly to blockchain networks 110. In the system 100, the refunding consumer 104 may provide the blockchain transaction identifier to the processing server 102 in a refund request to identify the blockchain transaction that is to be refunded. The refunding consumer 104 may also provide their public key or an address generated thereby that may be used to receive the refunded currency. In some cases, the refunding consumer 104 may also provide a digital signature generated using their blockchain wallet, which may be used by the processing server 102 (e.g., or blockchain network 110, as applicable) to verify that they were the payer in the initial transaction, to prevent a nefarious third party from receiving a refund for the refunding consumer's transaction.

The processing server 102 may receive the refund request from the refunding consumer 104 (e.g., via the refunder device 112, merchant system 106, etc., as applicable) and may identify the initial payment transaction and perform any verifications as necessary. In some cases, the refund request may include a reason code or other information indicating a reason for the refund. In some instances, merchant systems 106 may specify eligible reasons for a refund. In these instances, verification of the refund request may include verifying that an eligible reason was provided by the refunding consumer 104. For example, some merchant systems 106 may require the refunding consumer 104 to state that a product was defective to receive a refund. In cases where a physical product is being returned by the refunding consumer 104, proof of return of the physical product may be required. In these cases, proof may be provided through providing shipping information regarding return of the physical product or may be implied if the merchant system 106 submits or forwards the refund request to the processing server 102.

Once the refund request is verified, the processing server 102 may identify the amount that is to be refunded to the refunding consumer 104, which may be the amount paid to the merchant system 106 by the refunding consumer in the initial payment transaction (e.g., which may be adjusted due to taxes, fees, etc.). The amount being refunded may be referred to herein as the “refund amount.” In a traditional system, the merchant system 106 would initiate a reversal of the initial payment transaction, which may take a significant amount of time to process. In the system 100, the processing server 102 will await a subsequent payment transaction involving the merchant system 106. In some cases, the processing server 102 will wait for a subsequent transaction where the transaction amount is at least equal to the refund amount. In other cases, the processing server 102 may utilize multiple subsequent transactions for the bypass. In such cases, the methods and functions discussed below may be performed for each of the subsequent transactions.

For traditional payment transactions, the processing server 102 may receive an authorization request for the subsequent payment transaction. An authorization request may be a type of transaction message that is submitted to a payment network for processing. A transaction message is a data message that is formatted according to one or more standards governing the exchange of financial transaction messages, such as the International Organization of Standardization's ISO 8583 or ISO 20022 standards. An authorization request is a type of transaction message that is indicated as being an authorization request by a message type indicator included therein. An authorization request may include a plurality of data elements, where each data element is configured to store one or more pieces of transaction data. The transaction data may include, for instance, a transaction time, a transaction date, a transaction amount, account information for the payee of the payment transaction, account information for the payer of the payment transaction, currency type, geographic location, product data, offer data, reward data, loyalty data, etc. In the system 100, the authorization request received by the processing server 102 may include a primary account number associated with a transaction account utilized by a purchasing consumer 108 for funding the subsequent payment transaction, a transaction amount at least equal to the refund amount (except in instances where multiple subsequent transactions are used), and account details associated with the merchant system's transaction account used to receive funds for the payment transaction.

Instead of processing the authorization request, the processing server 102 may generate two new authorization requests. A first new authorization request may be generated where the purchasing consumer 108 is the payer (e.g., using the primary account number included in the received authorization request) and the refunding consumer 104 is the payee (e.g., using the account information in the initial payment transaction or supplied in the refund request) and the amount is for the refund amount. A second authorization request may be generated (e.g., newly generated or generated via modification of the received authorization request) that is for payment from the purchasing consumer 108 to the merchant system 106, but where the amount is for any remainder between the transaction amount of the subsequent payment transaction and the refund amount. Both authorization requests may then be processed using traditional methods and systems, where payment of the refund may thus be made directly to the refunding consumer 104 by the purchasing consumer 108 and where any excess may be paid to the merchant system 106 by the purchasing consumer 108. As such, the merchant system 106 may be bypassed in the processing of the refund.

For blockchain transactions, the processing server 102 may receive the data for a new transaction to be added to the blockchain. The data may include a digital signature generated by the purchasing consumer's blockchain wallet (e.g., the private key thereof), which may be generated by a purchaser device 114 possessed by the purchasing consumer 108, a recipient address generated using a public key of the merchant system 106, and a transaction amount. The data may also include any additional data necessary for processing a blockchain transaction, such as one or more references to past blockchain transactions where the purchasing consumer 108 was the recipient.

The processing server 102 may receive the data and may generate two new blockchain transactions. The first new blockchain transaction may include the digital signature generated by the purchasing consumer 108, the refund amount, and an address generated by the refunding consumer's public key (e.g., included in the refund request). The second new blockchain transaction may be a modification of the received blockchain transaction, but where the transaction amount has been adjusted to a remainder between the amount in the submitted blockchain transaction and the refund amount. In some cases, a single blockchain transaction may be used to effect both transfers. In these cases, the received blockchain transaction may be modified to have the refunding consumer's blockchain wallet as an additional recipient of the refund amount, with the amount going to the merchant system 106 being adjusted accordingly. For instance, the blockchain transaction, after modification by the processing server 102, may have multiple inputs (e.g., for all of the transactions being pooled by the purchasing consumer 108 into the transaction) and three outputs: one to the refunding consumer's blockchain wallet for the refund amount, one to the merchant system's blockchain wallet for the difference between the transaction amount and the refund amount, and one to provide any change (e.g., if the amount from the input transactions is greater than the transaction amount) back to the purchasing consumer's blockchain wallet. The blockchain transaction(s) may be transmitted to a node in the blockchain network 110 for verification and addition to the blockchain. In some embodiments, the processing server 102 may be a node.

The methods and systems discussed herein thus enable a refunding consumer 104 to receive a refund for a payment transaction, either a traditional fiat transaction or a blockchain transaction, directly from another consumer, effectively bypassing the merchant system 106 involved in the transaction being refunded. As a result, the refunding consumer 104 can receive their refund faster and merchant systems 106 can perform little to no actions entirely to ensure that the refund gets processed and the refunding consumer 104 gets paid.

Processing Server

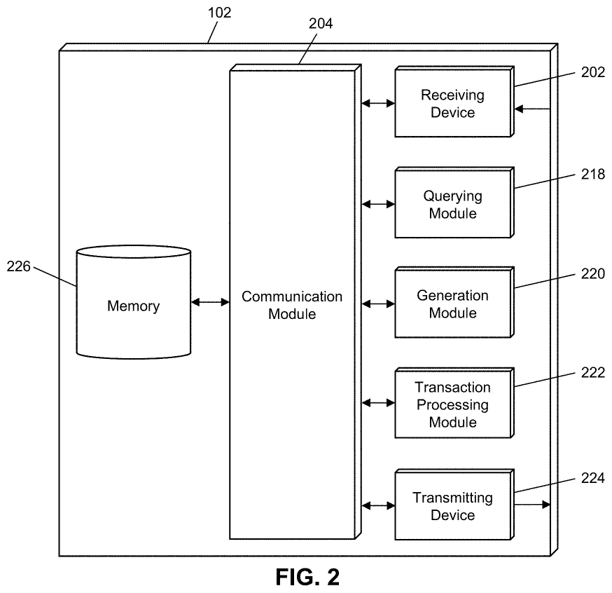

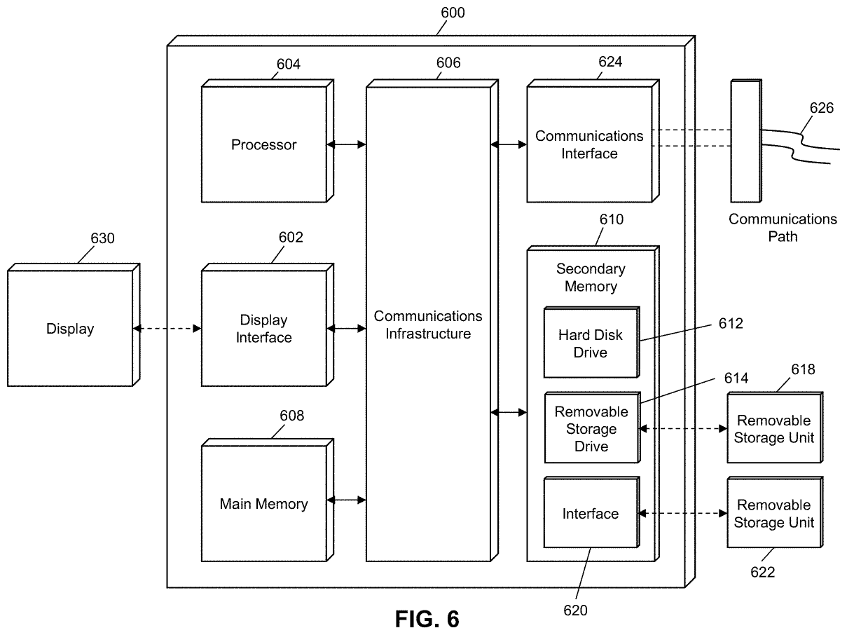

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from merchant systems 106, blockchain networks 110, refunder devices 112, purchaser devices 114, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by merchant systems 106 that may be superimposed or otherwise encoded with a public key associated with the merchant system's blockchain wallet, for use in generating blockchain addresses. The receiving device 202 may also be configured to receive data signals electronically transmitted by merchant systems 106 or refunder devices 112 that are superimposed or otherwise encoded with refund requests. A refund request may include an identifier associated with a payment transaction to be refunded, and may also include a reason code and/or any information necessary for the merchant bypass transaction, such as a recipient transaction account number, digital signature, public key, refund amount, etc. The receiving device 202 may also be configured to receive data signals electronically transmitted by merchant systems 106, purchaser devices 114, blockchain networks 110, payment networks, or other entities that are superimposed or otherwise encoded with data for a subsequent payment transaction, such as an authorization request for a traditional payment transaction or a blockchain data value for a new blockchain transaction.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, generation module 220, transaction processing module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include a querying module 218. The querying module 218 may be configured to execute queries on databases to identify information. The querying module 218 may receive one or more data values or query strings, and may execute a query string based thereon on an indicated database, such as a memory 226, to identify information stored therein. The querying module 218 may then output the identified information to an appropriate engine or module of the processing server 102 as necessary. The querying module 218 may, for example, execute a query on a memory 226 to identify the initial payment transaction or data associated therewith, to identify a public key used to generate a blockchain address for a new blockchain transaction, etc.

The processing server 102 may also include a generation module 220. The generation module 220 may be configured to generate data for use by the processing server 102 in performing the functions discussed herein. The generation module 220 may receive instructions as input, may generate data based on the instructions, and may output the generated data to one or more modules of the processing server 102. For example, the generation module 220 may be configured to generate notifications and other data messages for transmission to merchant systems 106, refunder devices 112, purchaser devices 114, such as prompts for digital signatures, public keys, account numbers, etc., as well as for transmission to nodes in the blockchain network 110, such as for a new blockchain transaction to be processed. The generation module 220 may also be configured to generate digital signatures and blockchain addresses using private and public keys, respectively, using suitable algorithms. The generation module 220 may also be configured to generate transaction messages, including authorization requests for use as merchant bypass transactions.

The processing server 102 may also include a transaction processing module 222. The transaction processing module 222 may be configured to perform functions for the processing server 102 related to the processing of electronic payment transactions as discussed herein. Such functions may include, for example, the forwarding of authorization requests and authorization responses, the generation of authorization requests or responses, the identification of issuing institutions, the swapping of an account number to/from a PAN in an authorization request or authorization response, the calculation of a fiat currency amount or blockchain currency amount via an exchange rate, etc.

The processing server 102 may also include a transmitting device 224. The transmitting device 224 may be configured to transmit data over one or more networks via one or more network protocols. In some instances, the transmitting device 224 may be configured to transmit data to merchant systems 106, refunder devices 112, blockchain networks 110, purchaser devices 114, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to merchant systems 106 or blockchain networks 110 that are superimposed or otherwise encoded with requests for transaction data for initial payment transactions. The transmitting device 224 may also be configured to electronically transmit data signals to blockchain networks 110 and payment networks that are superimposed or otherwise encoded with authorization requests or blockchain data values for processing thereby. The transmitting device 224 may be further configured to electronically transmit data signals to refunder devices 112, purchaser devices 114, or merchant systems 106, which may be superimposed or otherwise encoded with requests for data for use in refund and merchant bypass transactions, such as public keys, blockchain addresses, digital signatures, primary account numbers, etc.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, blockchain data, payment transaction data, public keys, key generation algorithms, digital signature generation and verification algorithms, transaction routing data, etc.

Process for Merchant-Bypassing Refunds

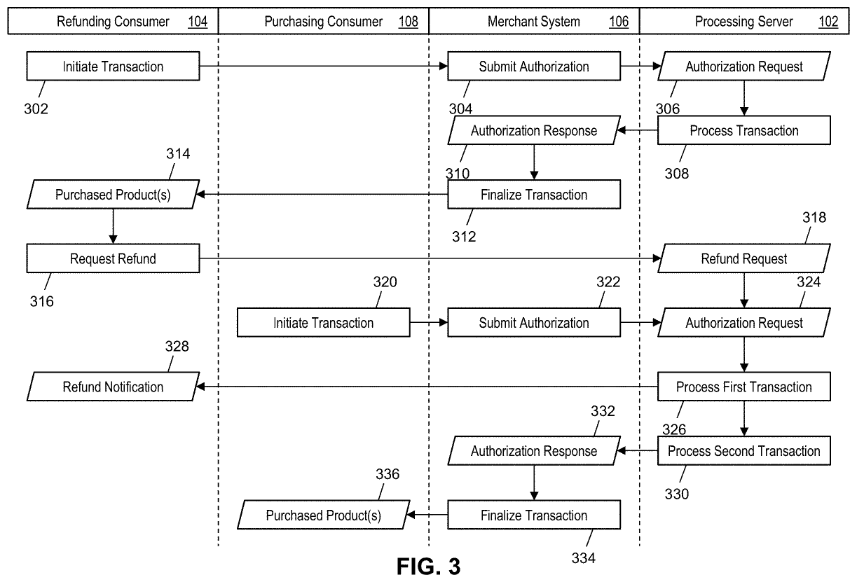

FIG. 3 illustrates an example process for the processing of a merchant-bypassing refund for an initial payment transaction using a subsequent payment transaction in the system 100 of FIG. 1. While FIG. 3 illustrates the process for a traditional payment transaction, the merchant bypass may also be conducted for a blockchain transaction, as discussed above.

In step 302, the refunding consumer 104 may initiate the initial payment transaction with the merchant system 106. The initial payment transaction may be a traditional payment transaction funded via a fiat currency and processed by a payment network, where the refunding consumer 104 provides their primary account number for the transaction account used to fund the payment transaction. In step 304, the merchant system 106 (e.g., or an entity acting on behalf of the merchant system 106, such as an acquiring institution or gateway processor) may submit an authorization request for the initial payment transaction to the processing server 102. In step 306, the receiving device 202 of the processing server 102 may receive the authorization request. The authorization request may include at least the primary account number for the funding transaction account, account details for the account used by the merchant system 106 to receive the funds, and a transaction amount.

In step 308, the transaction processing module 222 of the processing server 102 may process the payment transaction using traditional methods and systems. In some embodiments, a payment network may perform the processing of the payment transaction, where the processing server 102 may only be used for refunds. As part of the processing of the payment transaction, in step 310 the merchant system 106 may receive an authorization response for the transaction, where the authorization response includes a data element configured to store a response code indicating that the transaction was approved. In step 312, the merchant system 106 may finalize the payment transaction, which may include furnishing purchased goods or services to the refunding consumer 104. In step 314, the refunding consumer 104 may receive the purchased goods or services. As part of the processing of the payment transaction, the transaction amount may be paid from the refunding consumer's transaction account to one of the merchant system 106.

In step 316, the refunding consumer 104 may request a refund by submitting a refund request to the processing server 102 using a suitable method. In step 318, the receiving device 202 of the processing server 102 may receive the refund request. The refund request may include at least a transaction identifier associated with the initial payment transaction or other data that may be used by the processing server 102 to identify the initial payment transaction. In cases where the refunding consumer 104 may want the refund to be paid to a different transaction account than the one used in the initial payment transaction, the refund request may include a primary account number and/or other account details for the different transaction account.

Separate from the submission of the refund request to the processing server, in step 320, a purchasing consumer 108 may initiate a subsequent payment transaction with the merchant system 106. In step 322, the merchant system 106 (e.g., or an entity operating on behalf thereof) may submit an authorization request for the subsequent payment transaction to the processing server 102 for processing. In step 324, the receiving device 202 of the processing server 102 may receive the authorization request. The authorization request may include a primary account number associated with a transaction account of the purchasing consumer 108 to be used to fund the subsequent payment transaction, the account details of the merchant system 106, and a transaction amount, where the transaction amount is greater than the refund amount requested by the refunding consumer 104 for the initial payment transaction.

In step 326, the generation module 220 of the processing server 102 may generate a new authorization request for a first payment transaction, which may be processed by the transaction processing module 222 of the processing server 102. The authorization request for the first payment transaction may include the primary account number of the purchasing consumer 108 as the payer, the primary account number of the refunding consumer 104 as the payee, and the refund amount. As part of the processing of the first payment transaction, the transmitting device 224 of the processing server 102 may, in step 328, electronically transmit a notification of payment of the refund amount to the refunding consumer 104 to the refunding consumer (e.g., via the refunder device 112).

In step 330, the generation module 220 of the processing server 102 may generate a new authorization request for a second payment transaction, which may be processed by the transaction processing module 222 of the processing server 102. The authorization request for the second payment transaction may include the primary account number of the purchasing consumer 108 as the payer, the account information for the merchant system 106 as the payee, and the difference between the transaction amount in the subsequent payment transaction and the refund amount. In some cases, the authorization request for the second payment transaction may be a modification of the authorization request received in step 324. In step 332, the merchant system 106 may receive an authorization response for the subsequent payment transaction, which may reflect successful payment by the purchasing consumer 108 (e.g., and may indicate that the refund amount was taken out for payment of the refund to the refunding consumer 104, and where the initial payment transaction may be referenced therein). In step 334, the merchant system 106 may finalize the subsequent payment transaction, which may include furnishing purchased goods or services to the purchasing consumer 108. In step 336, the purchasing consumer 108 may receive the purchased goods or services. As part of the processing of the payment transaction, the transaction amount may be paid from the purchasing consumer's transaction account to one of the merchant system 106, as well as the payment of the refund amount from the purchasing consumer's transaction account to the refunding consumer's transaction account.

First Exemplary Method for Processing Merchant-Bypassing Refunds

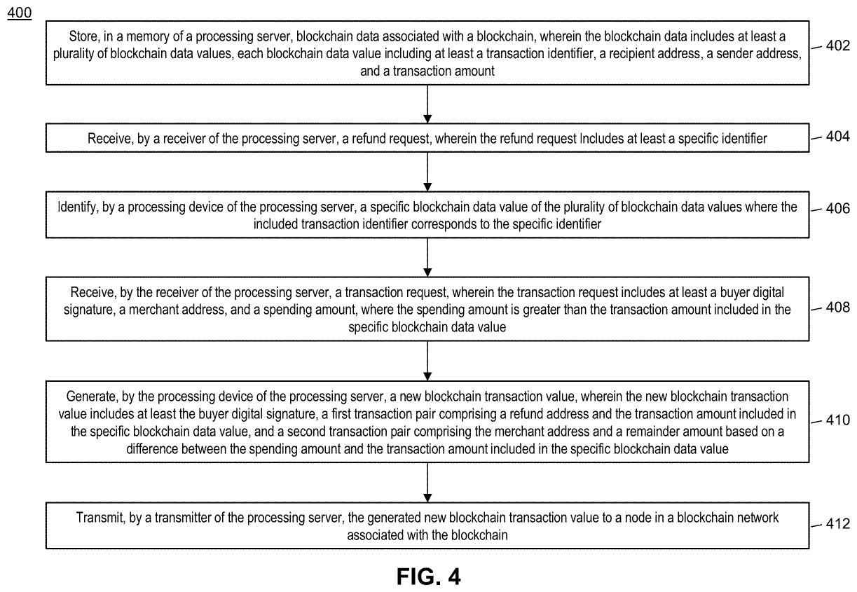

FIG. 4 illustrates a method 400 for the processing of a refund for a blockchain payment transaction that bypasses merchant involvement for direct payment of the refund from a second consumer to the refunding consumer.

In step 402, blockchain data associated with a blockchain may be stored in a memory (e.g., the memory 226) of a processing server (e.g., the processing server 102), wherein the blockchain data includes at least a plurality of blockchain data values, each blockchain data value including at least a transaction identifier, a recipient address, a sender address, and a transaction amount. In step 404, a refund request may be received by a receiver (e.g., the receiving device 202) of the processing server, wherein the refund request includes at least a specific identifier.

In step 406, a specific blockchain data value may be identified by a processing device (e.g., the querying module 218) of the processing server of the plurality of blockchain data values where the included transaction identifier corresponds to the specific identifier. In step 408, a transaction request may be received by the receiver of the processing server, wherein the transaction request includes at least a buyer digital signature, a merchant address, and a spending amount, where the spending amount is greater than the transaction amount included in the specific blockchain data value.

In step 410, a new blockchain transaction value may be generated by the processing device (e.g., the generation module 220) of the processing server, wherein the new blockchain transaction value includes at least the buyer digital signature, a first transaction pair comprising a refund address and the transaction amount included in the specific blockchain data value, and a second transaction pair comprising the merchant address and a remainder amount based on a difference between the spending amount and the transaction amount included in the specific blockchain data value. In step 412, the generated new blockchain transaction value may be electronically transmitted, by a transmitter (e.g., the transmitting device 224) of the processing server to a node in a blockchain network (e.g., the blockchain network 110) associated with the blockchain.

In one embodiment, the refund request may further include a refund digital signature, and the new blockchain transaction value may further include the refund digital signature. In some embodiments, the refund request may further include the refund address. In one embodiment, the specific blockchain data value may further include a public key, and the refund address may be generated using the public key.

Second Exemplary Method for Processing Merchant-Bypassing Refunds

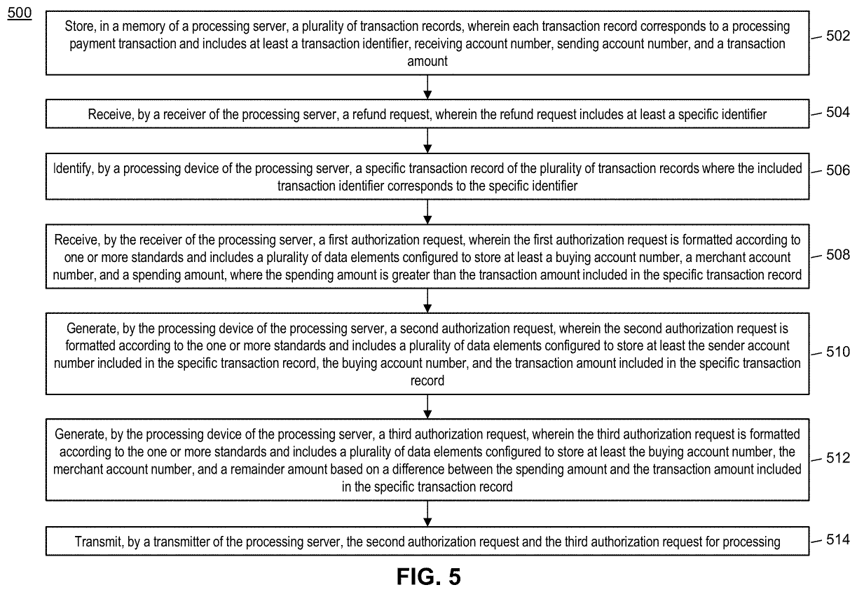

FIG. 5 illustrates a method 500 for the processing of a refund for a traditional payment transaction that bypasses merchant involvement for direct payment of the refund from a second consumer to the refunding consumer.

In step 502, a plurality of transaction records may be stored in a memory (e.g., the memory 226) of a processing server (e.g., the processing server 102), wherein each transaction record corresponds to a processing payment transaction and includes at least a transaction identifier, receiving account number, sending account number, and a transaction amount. In step 504, a refund request may be received by a receiver (e.g., the receiving device 202) of the processing server, wherein the refund request includes at least a specific identifier.

In step 506, a specific transaction record of the plurality of transaction records may be identified by a processing device (e.g., the querying module 218) of the processing server where the included transaction identifier corresponds to the specific identifier. In step 508, a first authorization request may be received by the receiver of the processing server, wherein the first authorization request is formatted according to one or more standards and includes a plurality of data elements configured to store at least a buying account number, a merchant account number, and a spending amount, where the spending amount is greater than the transaction amount included in the specific transaction record.

In step 510, a second authorization request may be generated by the processing server (e.g., the generation module 220), wherein the second authorization request is formatted according to the one or more standards and includes a plurality of data elements configured to store at least the sender account number included in the specific transaction record, the buying account number, and the transaction amount included in the specific transaction record. In step 512, a third authorization request may be generated by the processing server, wherein the third authorization request is formatted according to the one or more standards and includes a plurality of data elements configured to store at least the buying account number, the merchant account number, and a remainder amount based on a difference between the spending amount and the transaction amount included in the specific transaction record. In step 514, the second authorization request and the third authorization request may be transmitted by a transmitter (e.g., the transmitting device 224) of the processing server for processing.

In one embodiment, generating the third authorization request may include modifying data stored in the data elements included in the first authorization request. In some embodiments, the plurality of transaction records may be blockchain data values stored in a plurality of blocks comprising a blockchain. In one embodiment, the second authorization request and the third authorization request may be transmitted to a payment network using payment rails.

Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for processing merchant-bypassing refunds. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing merchant-bypassing refunds, comprising:
storing, in a memory of a processing server, blockchain data associated with a blockchain, wherein the blockchain data includes at least a plurality of blockchain data values, each blockchain data value including at least a transaction identifier, a recipient address, a sender address, and a transaction amount;
receiving, by a receiver of the processing server, a refund request, wherein the refund request includes at least a specific identifier;
identifying, by a processing device of the processing server, a specific blockchain data value of the plurality of blockchain data values where the included transaction identifier corresponds to the specific identifier;
receiving, by the receiver of the processing server, a transaction request, wherein the transaction request includes at least a buyer digital signature, a merchant address, and a spending amount, where the spending amount is greater than the transaction amount included in the specific blockchain data value;
generating, by the processing device of the processing server, a new blockchain transaction value, wherein the new blockchain transaction value includes at least the buyer digital signature, a first transaction pair comprising a refund address and the transaction amount included in the specific blockchain data value, and a second transaction pair comprising the merchant address and a remainder amount based on a difference between the spending amount and the transaction amount included in the specific blockchain data value; and
transmitting, by a transmitter of the processing server, the generated new blockchain transaction value to a node in a blockchain network associated with the blockchain.

2. The method of claim 1, wherein
the refund request further includes a refund digital signature, and
the new blockchain transaction value further includes the refund digital signature.

3. The method of claim 1, wherein the refund request further includes the refund address.

4. The method of claim 1, wherein
the specific blockchain data value further includes a public key, and
the refund address is generated using the public key.

5. A method for processing merchant-bypassing refunds, comprising:
storing, in a memory of a processing server, a plurality of transaction records, wherein each transaction record corresponds to a processing payment transaction and includes at least a transaction identifier, receiving account number, sending account number, and a transaction amount;
receiving, by a receiver of the processing server, a refund request, wherein the refund request includes at least a specific identifier;
identifying, by a processing device of the processing server, a specific transaction record of the plurality of transaction records where the included transaction identifier corresponds to the specific identifier;
receiving, by the receiver of the processing server, a first authorization request, wherein the first authorization request is formatted according to one or more standards and includes a plurality of data elements configured to store at least a buying account number, a merchant account number, and a spending amount, where the spending amount is greater than the transaction amount included in the specific transaction record;
generating, by the processing device of the processing server, a second authorization request, wherein the second authorization request is formatted according to the one or more standards and includes a plurality of data elements configured to store at least the sender account number included in the specific transaction record, the buying account number, and the transaction amount included in the specific transaction record;
generating, by the processing device of the processing server, a third authorization request, wherein the third authorization request is formatted according to the one or more standards and includes a plurality of data elements configured to store at least the buying account number, the merchant account number, and a remainder amount based on a difference between the spending amount and the transaction amount included in the specific transaction record; and
transmitting, by a transmitter of the processing server, the second authorization request and the third authorization request for processing.

6. The method of claim 5, wherein generating the third authorization request includes modifying data stored in the data elements included in the first authorization request.

7. The method of claim 5, wherein the plurality of transaction records are blockchain data values stored in a plurality of blocks comprising a blockchain.

8. The method of claim 5, wherein the second authorization request and the third authorization request are transmitted to a payment network using payment rails.

9. A system for processing merchant-bypassing refunds, comprising:
a memory of a processing server configured to store blockchain data associated with a blockchain, wherein the blockchain data includes at least a plurality of blockchain data values, each blockchain data value including at least a transaction identifier, a recipient address, a sender address, and a transaction amount;
a receiver of the processing server configured to receive a refund request, wherein the refund request includes at least a specific identifier;
a processing device of the processing server configured to identify a specific blockchain data value of the plurality of blockchain data values where the included transaction identifier corresponds to the specific identifier; and
a transmitter of the processing server, wherein
the receiver of the processing server is further configured to receive a transaction request, wherein the transaction request includes at least a buyer digital signature, a merchant address, and a spending amount, where the spending amount is greater than the transaction amount included in the specific blockchain data value,
the processing device of the processing server is further configured to generate a new blockchain transaction value, wherein the new blockchain transaction value includes at least the buyer digital signature, a first transaction pair comprising a refund address and the transaction amount included in the specific blockchain data value, and a second transaction pair comprising the merchant address and a remainder amount based on a difference between the spending amount and the transaction amount included in the specific blockchain data value, and
the transmitter of the processing server is configured to transmit the generated new blockchain transaction value to a node in a blockchain network associated with the blockchain.

10. The system of claim 9, wherein
the refund request further includes a refund digital signature, and
the new blockchain transaction value further includes the refund digital signature.

11. The system of claim 9, wherein the refund request further includes the refund address.

12. The system of claim 9, wherein
the specific blockchain data value further includes a public key, and
the refund address is generated using the public key.

13. A system for processing merchant-bypassing refunds, comprising:
a memory of a processing server configured to store a plurality of transaction records, wherein each transaction record corresponds to a processing payment transaction and includes at least a transaction identifier, receiving account number, sending account number, and a transaction amount;
a receiver of the processing server configured to receive a refund request, wherein the refund request includes at least a specific identifier;
a processing device of the processing server configured to identify a specific transaction record of the plurality of transaction records where the included transaction identifier corresponds to the specific identifier; and
a transmitter of the processing server, wherein
the receiver of the processing server is further configured to receive a first authorization request, wherein the first authorization request is formatted according to one or more standards and includes a plurality of data elements configured to store at least a buying account number, a merchant account number, and a spending amount, where the spending amount is greater than the transaction amount included in the specific transaction record,
the processing device of the processing server is further configured to
generate a second authorization request, wherein the second authorization request is formatted according to the one or more standards and includes a plurality of data elements configured to store at least the sender account number included in the specific transaction record, the buying account number, and the transaction amount included in the specific transaction record, and
generate a third authorization request, wherein the third authorization request is formatted according to the one or more standards and includes a plurality of data elements configured to store at least the buying account number, the merchant account number, and a remainder amount based on a difference between the spending amount and the transaction amount included in the specific transaction record, and
the transmitter of the processing server is configured to transmit the second authorization request and the third authorization request for processing.

14. The system of claim 13, wherein generating the third authorization request includes modifying data stored in the data elements included in the first authorization request.

15. The system of claim 13, wherein the plurality of transaction records are blockchain data values stored in a plurality of blocks comprising a blockchain.

16. The system of claim 13, wherein the second authorization request and the third authorization request are transmitted to a payment network using payment rails.
